(19) United States
(12) Patent Application Publication
(10) Pub. No.: US 2010/0151082 A1
(43) Pub. Date: Jun. 17, 2010

(54) METHOD FOR PREPARING A FROZEN DESSERT FROM A FROZEN COMPOSITION

(75) Inventors: Jean-Luc Rabault, Ponthevrard (FR); Jean-Marc Philippe, Leuville Sur Orge (FR); Benedicte Flat, Palaiseau (FR)

Correspondence Address: YOUNG & THOMPSON, 209 Madison Street, Suite 500, Alexandria, VA, 22314, US

(73) Assignee: COMPAGNIE GERVAIS DANONE, Paris (FR)

(21) Appl. No.: 12/594,464

(22) PCT Filed: Mar. 27, 2008
(86) PCT No.: PCT/FR2008/050528

§ 371 Date: Oct. 2, 2009

(30) Foreign Application Priority Data
Apr. 2, 2007 (FR) 07 02391

(51) Int. Cl. A23G 9/32; A23G 9/20; A23G 9/00

(52) U.S. Cl. 426/61; 426/660; 426/639; 426/565

(57) ABSTRACT

A method for preparing a frozen dessert includes the following steps: (a) adding onto a frozen composition contained in a vessel at least one additional powdery composition and/or from 3 to 18 wt % relative to frozen composition weight, of at least one additional liquid composition, the additional compositions containing not only sugar optionally mixed with water but also providing at least one nutritional benefit, in order to obtain a frozen composition with added liquid and/or powder; (b) placing the vessel containing the frozen composition with added liquid and/or powder in a texturizing device with grinding elements and optionally aeration elements; and (c) texturing the frozen composition with added liquid and/or powder in the texturing device.

This invention relates to a process for producing a frozen dessert from a frozen composition and an additional liquid composition and/or an additional liquid composition and/or an additional powdered composition.

Sorbets and ice creams are very popular among consumers owing to their sweet flavor and their freshness, which is especially agreeable in very warm climates.

They can be prepared at home by using ice cream makers. Numerous types of sorbets and ice creams are also available on the market and can contain a variety of ingredients such as fruit and/or yogurt.

It appears, however, that these desserts are not always nutritious for certain categories of people, whether because they contain a large amount of sugar and/or fat, which can lead to excess weight and even obesity, or because they do not contain enough or any ingredients that meet the specific nutritional requirements of certain consumers.

It would therefore be desirable to be capable of proposing a process enabling the composition of a frozen dessert to be adapted to a specific consumer immediately before consumption, according to the user's nutritional requirements, for example to be capable of adding fiber, milk or probiotics to it.

It is not, however, possible to add these ingredients to the frozen desserts on the market without affecting the organoleptic characteristics thereof (less appealing appearance, sticky, powdery feeling in the mouth, etc.) and therefore the palatability thereof. Document WO 99 02042 discloses such a frozen milk dessert containing lactic bacteria and coated with a support containing prebiotic fiber. Documents U.S. Pat. No. 5,308 628 and US 2005 106301 disclose other frozen desserts based on fermented milk, to which fruit can be added. In all of these documents, it is not recommended, and it is even discouraged, to grind or texture the dessert after adding fiber or fruits.

It would therefore be desirable to be capable of providing means enabling the nutritional composition of frozen desserts to be customized, immediately before consumption, without substantially affecting the organoleptic characteristics thereof.

With regard to collective establishments, such as restaurants, it is moreover known to produce soft ice creams (or “soft ice”) by using an apparatus manufactured by the PACOJET AG company (Zug, Switzerland) and sold under the commercial name Pacojet® by the PACOCLEAN company (Romagnieu, France).

This apparatus, described in patent application CA 2 250 542, is a multi-functional robot enabling in particular frozen desserts to be made from a frozen composition in special jars that is textured (ground and optionally aerated) or “pacotized” until the smooth consistency of an Italian gelato is obtained, in a few minutes.

It has never been suggested, however, to use this apparatus in a process enabling frozen desserts to be made with different nutritional compositions suitable for different consumers, using the same frozen composition block. Such a process would have the advantage of offering these consumers a good compromise between the undeniable organoleptic properties of frozen desserts and the need for balanced and targeted nutritional intakes.

In addition, this type of apparatus has the disadvantage of being costly, in particular for home use. Its use in such a process as defined above could therefore extend the range of uses and make the acquisition thereof profitable.

The applicant company has managed to develop such a process that involves the addition of powders and/or liquids of high nutritional value to a frozen composition block contained in a container, and texturization thereof in an apparatus of the type mentioned above. Surprisingly, while this apparatus is generally a poor mixer at the height of the container, the frozen desserts obtained according to this process have a very homogeneous texture and therefore very good organoleptic properties.

This invention thus relates to a process for producing a frozen dessert, including the series of steps consisting of:

a. adding, to a frozen composition contained in a container, at least one additional powdered composition and/or 3 to 18% by weight, with respect to the weight of the frozen composition, of at least one additional liquid composition, in which said additional compositions do not contain only sugar optionally mixed with water and providing at least one nutritional benefit, in order to obtain a frozen composition with added liquid and/or powder;

b. placing the container containing said frozen composition with added liquid and/or powder in a texturizing device equipped with grinding means and optionally aeration means, and

c. texturizing said frozen composition with added liquid and/or powder in said texturizing device.

The first step of the process according to the invention implements a frozen composition.

This composition can be an industrial composition available on the market either in frozen form or in refrigerated form, and which has subsequently been frozen, or a composition previously prepared at the site where the process is implemented (collectivity, in particular a restaurant, or preferably at home). By “industrial composition”, we mean, in the sense of this invention, a product packaged for sale in a closed container, generally having a recommended last consumption date, manufactured on an industrial scale, i.e. in a plant enabling at least several hundred or even several thousand or even several tens of thousands of 125-g units (or equivalent weight) of said product to be produced and packaged each day. Such a composition is normally available for sale outside of its manufacturing site, generally by means of a distribution network involving at least one wholesaler and/or retailer and/or distributor and/or delivery person.

The frozen composition advantageously contains fermented milk and preferably 51 to 70% by weight, more preferably 55 to 70% by weight, and, even better, 55 to 60% by weight fermented milk, with respect to the total weight of the composition.

The fermented milk used according to the invention can be yogurt or a fresh cheese.

This fermented milk can in particular be cow's milk, goat's milk, buffalo milk, soy milk, oat milk, or mixtures thereof. Cow's milk is preferred for use in this invention. Any fermentation conditions and ferments may be implemented.

In the sense of this invention, by “yogurt”, we mean a coagulated milk product obtained by lactic fermentation owing to the action of thermophilic microorganisms, obtained from Streptococcus thermophilus and Lactobacillus delbruekii bulgaricus cultures, milk and milk products. It is the presence of these two bacterial strains that characterizes the term yogurt, according to the definition of the Codex alimentarius. These specific microorganisms are preferably viable, in an aggregate amount of at least 10⁷ CFU/g on the recommended last consumption date, and the abbreviation CFU stands for Colony-Forming Unit. The lactic fermentation causes a reduction in the pH and coagulation of the proteins.

The milk products are chosen in particular from the group consisting of pasteurized milk, concentrated milk, partially skimmed pasteurized milk, partially skimmed concentrated milk, pasteurized skim milk, concentrated skim milk, pasteurized cream, pasteurized light cream, and mixtures thereof.

By extension, the term yogurt can also be used in the sense of this invention for products including lactic bacteria, other than the Streptococcus thermophilus and Lactobacillus delbruekii bulgaricus microorganisms, and in particular microorganisms obtained from Bifidobacterium animalis animalis and/or Lactobacillus casei and/or Lactobacillus plantarum and/or Lactobacillus acidophilus strains. These lactic strains are intended, after ingestion, to give the end product various properties, such as a good balance of intestinal flora. In the end product, the microorganisms are preferably in a viable state. They thus improve the digestibility of the dessert made from the composition according to the invention and confer probiotic properties thereon.

Such a yogurt thus advantageously meets the requirements of fermented milks and yogurts of standard AFNOR NF 04-600 and the codex standard StanA-11a-1975. Standard AFNOR NF 04-600 specifies, inter alia, that the product must not have been heated after fermentation. In addition, in a yogurt, milk products and raw milk material must represent at least 70% (m/m) of the end product.

It is preferable in this invention to have a large amount of living lactic ferments after freezing. Thus, the composition used according to the invention contains advantageously at least 10⁵, preferably at least 10⁶, and even at least 10⁷ bacteria per gram. These bacteria advantageously contain at least one bacterium chosen from: (a) Streptococcus thermophilus, (b) Lactobacillus delbruekii bulgaricus, (c) Bifidobacterium animalis animalis, (d) Lactobacillus casei, (e) Lactobacillus plantarum, (f) Lactobacillus acidophilus or mixtures thereof. The bacteria preferably contain a mixture of (a) Streptococcus thermophilus, (b) Lactobacillus delbruekii bulgaricus, and optionally also (c) Bifidobacterium animalis animalis, and/or (d) Lactobacillus casei, and/or (e) Lactobacillus plantarum, and/or (f) Lactobacillus acidophilus.

Such a yogurt is sold in particular by the DANONE company under the commercial name Activia (Streptococcus thermophilus, Lactobacillus delbruekii bulgaricus, Bifidobacterium animalis animalis).

According to a preferred embodiment of the invention, the frozen composition also contains one or more fruits in the form of pieces, purée and/or juice.

By “fruit purée and/or juice”, we mean a more or less liquid preparation, in particular according to the nature of the fruit and/or the fineness of the grinding, prepared by grinding, pressing or another process for extracting one or more fruit(s) and optionally concentration of the ground material obtained and/or separation (in particular filtration) of the pips, seeds, and/or all or some of the pump, and/or flash pasteurization, in which the preparation does not contain added sugar. As certain commercial fruit purées contain added sugars, for example conventionally 10% sucrose, the added sugars will be counted as sugars and removed from the weight of the fruit purée, according to this invention.

In the sense of this invention, the fruit preparation (purée and/or juice) advantageously consists of fruits having a relatively small size in order to pass through a sieve having a 3-mm square mesh, in which said sieve is optionally rinsed with water during the sieving if the preparation is highly viscous.

In the description below, the amount of fruit implemented according to the invention is expressed as a fruit equivalent. By “fruit equivalent”, we mean, for example, in the case of a purée, the percentage of fruit purée (as defined above) implemented, multiplied by the percentage of dry matter of the fruit purée used, divided by the average percentage of dry matter of a non-concentrated purée of the edible portion of these same fruits when fresh. For example, if the composition according to the invention contains 20% of a fruit purée concentrated twice (of which half of the water has been evaporated), then sweetened by 10%, the fruit equivalent will be: 20×0.9×2/1 =36%.

We can thus use the standard fruit purées sold by the BOIRON FRERES SA company (Rungis, France).

The frozen composition used according to the invention preferably contains 30 to 220% by weight, more preferably 31 to 40% by weight and, even better, 31 to 35% by weight fruit, in fruit equivalent, with respect to the total weight of the frozen composition. Alternatively, however, the frozen composition can contain less than 30% by weight fruit or an amount of fruit ranging from 50 to 150% by weight, and preferably from 50 to 90% by weight fruit, in fruit equivalent, with respect to the total weight of the frozen composition.

The fruits can be chosen from the following: apple, banana, strawberry, peach, raspberry, mulberry, mango, kiwi, blueberry, black currant, gooseberry, orange, cherry, fig, pear, apricot, coconut, passion fruit, guava, papaya, melon, lychee, pineapple, lemon, mandarin orange, plum, grapefruit, grape, rhubarb and mixtures thereof. This list is non-exhaustive.

It is preferable for the frozen composition not to contain more than 50% by weight, and, even better, no more than 30% by weight fruit pieces, with respect to the total weight of fruit in the form of purée, juice and pieces, or even not to contain any fruit pieces, i.e. fruit capable of being held back on a 3-mm square mesh even after washing the mesh with water.

In addition, according to a preferred alternative of the invention, the frozen composition is free of non-fermented cream. Even more preferably, fermented milk is the only milk ingredient in the composition.

By “non-fermented cream”, we mean a milk enriched with fats, containing at least 30% by weight fat, in general 35% and even up to 40% by weight fat, which is generally liquid, with a pH close to 6.4, and not acidified by lactic ferments.

The absence of a non-fermented cream enables the number of ingredients of the composition and the fat content thereof to be reduced, and also enables better digestibility of the lactose to be ensured (known for yogurt).

Alternatively or in addition, the frozen composition can contain at least one of the following constituents: food additives (in the sense of the Codex alimentarium), in particular texturizing agents, emulsifiers, coloring agents, preservatives, starch, gelatin, flavoring agents, egg yolk and mixtures thereof. It is preferable however for the frozen composition to be free of at least one of these constituents and preferably all of these constituents.

By “texturizing agent”, we mean compounds that modify the texture of the products in which they are incorporated. Examples of texturizing agents are: guar gum and carob bean gum; gum arabic; xanthan and gellan; carrageenan; starches (native or modified); microcrystalline cellulose; gelatin; pectin; alginates (E400 to E405); agar-agar; and mixtures thereof. By “emulsifiers”, we mean amphiphilic compounds characterized by their HLB (Hydrophile Lipophile Balance) value, in particular capable of stabilizing oil-in-water emulsions. Examples of food emulsifiers are lecithin and derivatives thereof present in particular in egg yolk; fatty acid mono- and diglycerides; and polysorbate 80. By “coloring agents”, we mean natural or synthetic compounds capable of alone conferring a coloring on the composition. Examples of food colorings are known in Europe under codes E100 to E180. By “preservatives”, we mean compounds inhibiting the proliferation of micro-organisms, in particular yeast and/or mold and/or bacteria, in particular Staphylococcus Aureus, in the composition. Examples of food preservatives are sorbic acid and salts thereof (E200 to E203); benzoic acid and salts thereof (E210 to E219), sulfites and derivatives thereof (E220 to E228); natamycin; nisin; and mixtures thereof. By “flavoring agents”, we mean natural or synthetic compounds capable alone of modifying the flavor of the composition. Examples of flavoring agents are vanillin;

natural vanilla extract; added citrus essential oils; and mixtures thereof.

The frozen composition used according to the invention can advantageously contain one or more non-hydrogenated vegetable oils containing unsaturated fatty acids, such as soybean oil, sunflower oil, oleic colza oil, oleic sunflower oil, safflower oil, evening primrose oil, or borage oil. More preferably, it is possible to use one or more oils rich in omega-3 and optionally omega-6 fatty acids, preferably having a ratio of omega-6 fatty acids to omega-3 fatty acids below 5, such as nut oil, lupin oil, camelina oil, linseed oil, hempseed oil, cranberry oil, Inca Inchi oil, kiwi seed oil or colza oil, preferably colza oil owing to its very neutral flavor and its lower cost.

Of nutritious oils are used as a partial or total replacement for the lactic fat, the frozen composition according to the invention will preferably have an omega-3 fatty acid content (in linolenic acid equivalent) greater than 0.3 g per 100 g of frozen dessert (for example provided by 3.3% colza oil). Preferably, the ratio of omega-6 fatty acids to omega-3 fatty acids is also lower than 5, and preferably lower than 33% of the calories in the frozen composition are fats.

The applicant has also noted that the flavor of the fruit is more intense if the overall fat content is lower, or when the fats are provided in the form of vegetable oils. The color of the fruit is also brighter.

The frozen composition used according to the invention contains, as a third constituent (optional), one or more added sugars (in addition to those naturally present in the fruit) in an amount so that the composition advantageously contains less than 25% by weight, preferably less than 23% by weight and, even better, less than 21% by weight carbohydrates, with respect to the total weight of the composition. It also preferably contains more than 14% by weight carbohydrates, with respect to the total weight of the composition.

By sugar or sugars, we mean, in the sense of this invention, any sweetening carbohydrate, preferably sucrose, glucose, fructose, invert sugar, honey, maltose, or mixtures thereof, in particular in a proportion of 50:50. The sugar is preferably added in the form of a fine powder such confectioners' sugar.

The frozen composition obtained by mixing the aforementioned ingredients advantageously has an energy value below or equal to 155 KCal/100 g, preferably below 140 KCal/100 g, more preferably below 120 KCal/100 g, and even 100 KCal /100 g, and generally above 40 KCal/100 g, and preferably above 80 KCal/100 g and even 90 KCal/100 g.

In addition, it preferably contains 0 to 3%, or even 0 to 6% by weight, and preferably 0 to 1% by weight fat and/or 1.5 to 3%, or even 2 to 2.5% by weight protein and/or less than 25% by weight, preferably less than 23% by weight, and, even better, less than 21% by weight carbohydrate, with respect to the total weight of the composition.

It is generally preferable for the frozen composition used according to the invention to contain at most six ingredients and, even better, only three, with the understanding that all of the fruits and flavoring agents each count for one ingredient.

To freeze the composition used in the first step of the process according to the invention, it is possible to use freezing in a four-star freezer for a period of at least 12 hours, and preferably at least 24 hours, or in a cell blowing a gas at −40° C. or less, for example −60° C. (classic cold or cryogenic tunnel), for faster freezing, as this latter alternative enables better survival of the ferments and reduced ice crystal growth, which will then be easier to grind. Obviously, it is also possible to freeze the mixture of ingredients at intermediate temperatures.

This freezing step is preferably performed so as to obtain a frozen composition having a core temperature less than or equal to −18° C. and generally greater than or equal to −40° C., for example a core temperature ranging from −20 to −30° C., and, even better, −24 to −30° C.

The frozen composition thus obtained is generally very hard and cannot be tasted as such, but will be used to produce a frozen dessert according to the invention.

If the frozen composition has been frozen at a core temperature of −18° C. to −30° C., it may be used as such. Alternatively, and as indicated above, the frozen composition may have been obtained or even preserved at a temperature ranging to −40° C. or less, in which case it will advantageously be brought to a core temperature as indicated above, before implementation of the first step of the process according to the invention.

Preferably, this frozen composition is not significantly aerated, i.e. its density is advantageously greater than 850 g/l and preferably greater than 950 g/l.

In this first step, the frozen composition described above is packaged in a container intended and suitable for being subsequently inserted into a texturizing device.

The composition may have been poured into this container before freezing. It may alternatively have been placed therein after freezing, if it was packaged in another container intended for being sold in frozen form or in refrigerated state, and this other container is then advantageously designed to enable easy mold removal of the composition after freezing, so as to easily transfer it into the container intended to be placed in the texturizing device.

In the latter case, it will then be advantageous to provide, in the process above, a step of placing said frozen composition in the container by one of the following two processes:
by impregnation of the frozen composition with a small amount (less than 3% by weight) of an aqueous liquid such as water or a small amount of fat having a composition such that will quickly solidify at a temperature of <−15° C. (for example cocoa butter). The impregnation can be performed by steeping the frozen composition in water or another liquid, by passing it under water, or by pouring a liquid in the empty space surrounding the frozen composition block inside the container;
by warming it up, enabling the surface of the frozen composition block to melt,

the non-frozen aqueous portion or the fat is then solidified either by simple contact with the frozen portion or by returning it to the freezer.

This additional step eliminates the need to rotate the frozen composition in the container, which is detrimental to the success of the subsequent texturization, and which may adversely affect the homogeneity of the texturized mixture.

Also in the first step of the process according to the invention, at least one additional powdered composition and/or 3 to 18% by weight, with respect to the weight of the frozen composition, of at least one additional liquid composition are added to the frozen composition described above, contained in its container; said additional compositions do not contain only sugar optionally mixed with water, and provide at least one nutritional benefit.

By this last expression, we mean that the additional compositions are capable of providing:
high-quality nutritional ingredients, i.e. providing at least one constituent chosen from among: dietary fibers, vitamins, minerals, antioxidants, proteins, probiotics, prebiotics, omega-3 fatty acids and mixtures thereof,
or a functional ingredient, which will provide a physiological benefit demonstrated in particular in the scientific literature, such as an increase in natural defenses, weight management, satiety, prevention or treatment of a pathological disorder or a disorder due to aging or to a dietary deficiency, in particular rickets, diarrhea, constipation, osteoporosis, cancer (in particular breast or prostate cancer), cardiovascular diseases or diabetes. They can be functional foods containing active principles such as tomato lycopene, soy isoflavones, omega-3 fatty acids, serol or stanol esters, beta-glucans, flavonoids, probiotics or prebiotics.

More specifically, when it is powdered, it is preferable for the additional composition to include or consist of at least one constituent chosen from: dietary fibers, vitamins, minerals, antioxidants, proteins, probiotics, prebiotics and mixtures thereof.

By “prebiotic”, we mean a food component, generally non-digestible, capable of selectively stimulating the growth and/or the activity of probiotics normally present in the colon for a beneficial effect on the body. The prebiotic can in particular be considered to be a food for non-pathogenic bacteria of the colon. Examples of prebiotics are: fructo-oligosaccharides (FOS), oligofructose, inulin, lactulose, mucilages and galactose and transgalactose oligosides (GOS and TOS).

By “probiotic”, we mean a living microorganism (bacteria or yeast), which, ingested in a sufficient amount, is capable of living during intestinal transit and is beneficial to the health of the host. Probiotics can thus assist in digestion of lactose, dietary fiber and/or stimulate the immune system and/or prevent or treat diarrhea. Examples of probiotics are bifidobacteria, lactobacilli such as Lactobacillus plantarum, Lactobacillus acidophilus, Lactobacillus johnsonii, Lactobacillus casei (in particular the strain deposited under no. I-1518), Lactobacillus Goldbach&Goldi and Lactobacillus rhamnosus, Lactococcus and Enterococcus, Bifidobacterium breve, Bifidobacterium lactis BB12. An example among yeasts is Saccharomyces cerevisiaie, boulardii variant. It is thus possible to use dehydrated viable probiotics (ferments or yeast). It is preferable for the sum of the probiotics used according to the invention to be in an amount of at least 10⁷ CFU per gram of additional added composition, preferably at least 10⁸ CFU and, even better, at least 10⁹ CFU per gram.

Examples of fibers include or consist of inulin or fructo-oligosaccharides (FOS). The fibers are particularly suitable for producing food products intended for people suffering from constipation. They are advantageously used in an amount of 2 to 10% by weight, with respect to the weight of the frozen composition.

Examples of vitamins include at least one vitamin chosen from: vitamin A, vitamin B9, vitamin C, vitamin D, vitamin E and mixtures thereof.

The minerals can include at least one calcium, magnesium, phosphorus, iron, copper, fluorine, or iodine salt or antioxidant minerals such as zinc or selenium.

As other examples of antioxidants, at least one compound chosen from the following can be cited: carotenoids such as lycopene, polyphenols such as flavonoids and in particular isoflavones, tea polyphenols, fruits, cereal grains or cocoa. Soy isoflavones are very suitable for producing frozen desserts for menopausal women.

Finally, it is preferable for the proteins to include at least one protein chosen from: vegetable proteins obtained in particular from soy and animal proteins obtained in particular from milk. Milk powder is preferred for use in this invention insofar as it also constitutes a calcium source and enables very homogeneous products to be obtained. It is very suitable in particular for producing food products intended for growing children, in particular those who do not like the taste and/or texture of milk products. Advantageously, the milk powder is used in an amount of 1 to 12% and preferably 1 to 8% by weight, with respect to the weight of the frozen composition.

In addition, the additional powdered composition can contain other constituents such as those mentioned above and in particular a sugar such as those described above, capable of being incorporated in the basic frozen composition, with the understanding that it cannot consist exclusively of sugar.

By “powdered”, we mean a food ingredient or a mixture of such ingredients, in the form of a powder before being incorporated in the frozen composition. These powders generally have a water content of <15%, preferably <8% and even <5%. As a non-preferred alternative, pieces containing the same proportion of water are also included, and which will easily be reduced to powder by the blade of the texturizing device before it comes into contact with the frozen composition, such as lyophilized fruits.

The aforementioned constituents of the additional powdered composition and/or the sugars can be provided in the form of plant extracts such as fruits.

It is preferable for the additional powdered composition implemented according to the invention to contain powders having a particle size so that at least 90% by weight of the particles have a diameter (D90) smaller than 800 μm, preferably smaller than 500 μm, more preferably smaller than 250 μm, and, even better, smaller than 100 μm, or even smaller than 70 μm.

The applicant has demonstrated that the addition of powders to the frozen composition used in the process according to the invention did not generally adversely affect the homogeneity of the frozen dessert obtained. If, however, some of the aforementioned powders, used as such, do not enable a sufficiently homogeneous product to be obtained, it will be possible to pre-mix them with at least one of the following powders: confectioners' sugar, milk powder, oligo-fructosaccharide powder or inulin powder, before they are implemented in the process according to the invention.

The additional powdered composition can be added in an amount representing for example 1 to 20%, preferably 1 to 15%, more preferably 2 to 12% and, even better, 3 to 10% by weight, with respect to the weight of the frozen composition.

Alternatively, the additional composition implemented according to the invention can be a liquid composition.

By “liquid composition”, we mean a food ingredient or a mixture of such ingredients, in the form of a liquid before being incorporated in the frozen composition, either because they are available in liquid form, such as milk, or because the blade of the texturizing device has previously liquefied them before it comes into contact with the frozen composition, such as thixotropic products in solid form in the absence of shearing and which liquefy after shearing, including set yogurts.

Such an additional liquid composition normally contains less than 20% by weight fat, less than 30% by weight sugars and less than 5% by weight alcohol. It is understood that these amounts must be respected if a plurality of additional liquid compositions are used, in the overall composition resulting from the combination thereof.

According to a preferred alternative, the additional liquid composition implemented according to the invention contains at least 0.2% by weight proteins and preferably at least 2% by weight proteins. It is advantageously a liquid composition containing or consisting of milk, such as the types of milk described above. Milk provides in particular a calcium supply making it very suitable for producing food products for growing children. Cow's milk is preferred for use in this invention. It can be skim milk, half-skimmed or whole milk, with skim milk being preferred. It can also be concentrated milk, sweetened or not. It can also be fermented or non-fermented milk. Advantageously, the milk is not fermented. This milk can also have added soluble dietary fibers and in particular fructo-oligosaccharides or inulin.

Alternatively, the additional liquid composition can include or consist of at least one of the following constituents: a fruit juice, a liquid fruit purée, a soluble fiber syrup, in particular fructo-oligosaccharides or inulin, and mixtures thereof.

This liquid composition can be at a temperature ranging from 1 to 40° C., for example from 14 to 26° C. but more preferably 1 to 10° C. Alternatively, it can be at a higher temperature, for example ranging from 40 to 100° C., in particular if it is too viscous at room temperature to be poured onto the frozen composition or in order to obtain a softer frozen dessert.

It is used, according to the invention, in an amount of 3 to 18% by weight, and preferably 3 to 14% by weight and more preferably 5 to 10% by weight, with respect to the weight of the frozen composition. It was demonstrated by the applicant that the use of an additional liquid composition in the aforementioned amounts did not substantially modify the texture of the frozen dessert obtained and was generally sufficient to provide the specific desired nutritional benefits—for example, a significant portion of the recommended daily allowance of calcium—in an individual portion of the dessert, and to limit the viscosity of the additional liquid composition, in particular if it contains fiber and/or protein. By “significant portion” of the recommended daily allowance (RDA), we mean at least 15%, and even 30%, thereof.

A person skilled in the art will be able to adjust the temperature and the amount of the additional liquid composition according to the desired texture. In general, it is nevertheless preferable for the texture of the frozen dessert not to be substantially altered according to whether the frozen composition is textured with or without an additional liquid composition, i.e. it preserves the texture of ice cream and a temperature below 0° C., for example ranging from 0 to −10° C.

It is also preferable for this additional liquid composition not to consist exclusively of water.

The second step of the process according to the invention then consists of placing the aforementioned frozen composition with added liquid and/or powder in a texturizing device equipped with grinding means and optionally aeration means. This device generally does not have extrusion means.

Preferably, the grinding means include a grinding element equipped with rotary blades, mounted at the end of an axle that is adjusted so as to move longitudinally, perpendicularly to the plane of the blades. The aeration means can consist of any means enabling air to be added to the composition, generally under pressure. The grinding can also be performed at atmospheric pressure, in particular when the frozen composition contains fruit with a relatively subtle color and/or flavor, such as peach.

A device of this type was described in particular in the patent application CA-2 250 542 and is, for example, sold by the PACOCLEAN company under the commercial name Pacojet®.

Alternatively, the grinding means can include a grinding element equipped with rotary blades, mounted at the end of a non-sliding rotary axle, and the device can contain means for moving longitudinally, perpendicularly to the plane of the blades, and the container contains the frozen composition with added liquid and/or powder.

A device of this type is in particular made available on the market by the NEMOX S.p.A company (Italy), under the commercial name Frix-Air®.

In any case, the device can also include means for varying the ratio of the blade rotation speed to the rate of longitudinal movement.

Owing to the configuration and the blade rotation speed, for example around 2000 rpm, these devices enable, in the third step of the process according to the invention, the frozen composition to be cut into fine plates, mixed with the additional liquid and/or powdered composition, ground with hard ice crystals and optionally enable the mixture to be aerated so as to obtain a frozen dessert suitable for immediate tasting, generally within ten minutes, directly in the jar, or served in another container, for example in the form of scoops or balls.

The texturization implemented in the third step of the process according to the invention is advantageously performed immediately after the second step, i.e. less than 10 minutes, preferably less than 5 minutes and even less than one minute, after said step. In a non-preferred alternative of the invention, in order to obtain a more homogeneous texture, it is possible to perform an immediate second texturization.

The frozen dessert obtained preferably meets at least one, and more preferably all, of the conditions below:
it contains less than 3% by weight, preferably less than 2% by weight, more preferably less than 1% by weight, and, even better, less than 0.8% by weight fat, with respect to the total weight of the product;
it has no food additives;
it contains less than 15% by weight added sugar, and preferably less than 12%;
its energy value ranges from 40 to 120, preferably 40 to 100 and more preferably 40 to 85 KCal/100 g;
its temperature is below or equal to 0° C.

In addition, it contains advantageously at least 10⁵ probiotics per gram, preferably at least 10⁶ probiotics per gram and more preferably at least 10⁷ probiotics per gram.

The invention will now be illustrated with the following non-limiting examples.

### EXAMPLES

### Example 1

### Dessert Preparation Based on a Frozen and Powdered Composition

### Example 1A

### Preparation of a Frozen Composition

The recipe used is the following: 54.1% by weight DANONE small plain yogurt (made of 1.05% fat milk, concentrated or skim milk powder, lactose, milk proteins and yogurt lactic ferments; and containing 1% fat, 6.8% carbohydrates, 3.8% protein and 88.4% water and minerals); 34.4% by weight 10% sweetened raspberry purée, supplied by BOIRON (having been subjected to flash pasteurization before freezing); and 11.5% by weight sucrose in the form of confectioners' sugar.

The raspberry purée is defrosted for 24 hours at 4° C. The fruit purée is then mixed with the confectioners' sugar, then the mixture is mixed with the small plain yogurt. These mixtures are produced using a whisk. The final mixture is assayed at 350 g into metal jars specially designed to be inserted in the Pacojet® apparatus and closed by a lid, and then frozen in a pulsed air cell at −40° C. until the core temperature is below or equal to −30° C. The jars are then stored at −28° C.

The nutritional composition of the frozen composition thus obtained is as follows:

Energy value: 102 KCal/100 g

Proteins: 2.4%

Carbohydrates: 21.8%

Fats: 0.6%

Additives: none

Flavorings: none

These jars can be inserted into the Pacojet® apparatus and texturized according to the manufacturer's recommendations so as to obtain frozen desserts in the form of smooth, melting “soft ices”.

### Living Lactic Bacteria Count After Preservation:

After preserving at −28° C. for 1, 2, 4 and 9 months, the living ferments present were counted according to the following process: the jars containing the desserts were texturized with the Pacojet® as described above, then the desserts were sampled and placed at 4° C. for 12 hours, after which the viable flora was quantified. Each sample was texturized only once (there was a separate jar for each preservation time). Of all of these samples, it was the count was between 3×10⁷ and 6×10⁸ CFU/g. These frozen desserts therefore contain living ferments in the sense of the French Regulations.

Alternatively, the raspberry purée used in the production of the frozen block can be replaced with other fruit purées and in particular pineapple, mango, and so on.

The process according to the invention also enables frozen desserts to be produced with different specific nutritional profiles, based on these frozen composition jars, as will be described below.

### Example 1B

### Addition of a Skim Milk Powder

Skim milk powder (SMP Medium Heat supplied by EPI INGREDIENTS, containing: 348.1 KCal; 35.7 g of proteins; 0.5 g of fats; 53.1 g of carbohydrates; 3 g of water; and 7.7 g of minerals) at 20° C. was added in a variable amount to the 350-g frozen composition block obtained as described in example 1A. The tests were specifically conducted using 2%, 5%, 7%, 9% and 12% SMP.

The frozen composition with added powder was then immediately texturized (a single time) in the Pacojet® apparatus, using the standard air injection thereof.

A frozen foam was thus obtained, with a homogeneous color, lighter than that of the “soft ice” of example 1A, a more aerated texture and a temperature close to that of the latter (−6±1.5° C.), regardless of the amount of SMP added. The best compromises, in terms of flavor and texture, were obtained by adding 7 and 9% SMP.

In addition, the addition of 7% SMP enables the calcium supply to be multiplied, from 70 mg/100 g in the frozen block of example 1A to 149 mg/100 g (i.e. 18.6% of the Recommended Daily Allowance) in the frozen foam obtained according to example 1B. It is noted that the calcium supply with this frozen foam is thus greater than that of milk (120 mg/100 g). In addition, this frozen foam does not contain any additives or added flavorings and contains living lactic bacteria (around 5×10⁷ CFU/g). It therefore has a nutritional profile very suitable for growing children.

### Example 1C

### Addition of Powdered Fructo-Oligosaccharides

Using a process similar to that of example 1B, 2.9% by weight fructo-oligosaccharides (FOS—Actilight 950P) was added to the frozen block of example 1A. A very homogeneous frozen dessert with an agreeable taste, a very smooth, nice texture and melting in the mouth, was obtained. A similar dessert, but with a sweeter taste, was obtained by adding 9.1% by weight FOS. In both cases, the scoops formed had the same content as those obtained from the “soft ice” of example 1A.

The desserts obtained have a temperature of around −7° C.

### Example 1D

### Addition of Powdered Inulin

Using a process similar to that of example 1B, 3.3% by weight inulin (Raftiline ST GEL®) was added to the frozen block of example 1A. A very homogeneous frozen dessert was obtained with a nice texture, smoother and less hard than that of the “soft ice” obtained in example 1A without the addition of powder.

Similar tests performed with 9.1% by weight inulin gave similar results and a dessert less sweet and with a more elastic texture than that obtained in example 1C, with the same amount of FOS.

The desserts obtained have a temperature of around −7° C.

### Example 2

### Preparation of Desserts From Frozen and Liquid Compositions

### Example 2A

### Addition of FOS Syrup

3% by weight FOS syrup (Actilight® 950S), containing 72% dry matter and of which 95% of the dry matter consists of fiber, was added to the frozen block of example 1A. The dessert obtained had a very homogeneous and smooth texture. Its temperature was around −6° C.

### Example 2B

### Addition of Milk

10% by weight milk at 4° C. or at 90° C. was added to the frozen block of example 1A.

In the first case, a “soft ice” was obtained with a lighter color and a slightly less firm and more aerated texture than the “soft ice” obtained in example 1A without the addition of liquid. The milk qualities were more present and the fruit flavor was less intense. The frozen dessert was considered to be good.

In the second case, an even less firm texture was obtained.

The two milk-based desserts had 96 KCal/100 g and an amount of added sugar of 13.5%, whereas the “soft ice” of example 1A had 102 KCal/100 g and 15% added sugar.

### Example 2C

### Addition of Grape Juice

10% white grape juice at 4° C. was added to the frozen block of example 1A. After texturization using the standard air injection of the Pacojet® apparatus, a frozen dessert was obtained with the texture of a “soft ice”. The sweet flavor perceived is slightly more pronounced than that of the “soft ice” of example 1A, and the grape flavor is slightly perceptible; the color remains unchanged.

This dessert enables vitamins and minerals to be provided while reducing the caloric load of the “soft ice” of example 1A and the sugar content thereof.

1-34. (canceled)

35. Process for producing a frozen dessert, including the series of steps consisting of:
a. adding, to a frozen composition contained in a container, at least one additional powdered composition, in which said additional composition does not contain only sugar and providing at least one nutritional benefit, in order to obtain a frozen composition with added powder;
b. placing the container containing said frozen composition with added powder in a texturizing device equipped with grinding means, and
c. texturizing said frozen composition with added powder in said texturizing device.

36. Process for producing a frozen dessert, including the series of steps consisting of:
a. adding, to a frozen composition contained in a container, 3 to 18% by weight, with respect to the weight of the frozen composition, of at least one additional liquid composition, in which said additional composition does not contain only sugar mixed with water and providing at least one nutritional benefit, in order to obtain a frozen composition with added liquid;
b. placing the container containing said frozen composition with added liquid in a texturizing device equipped with grinding means, and
c. texturizing said frozen composition with added liquid in said texturizing device.

37. Process according to claim 35, wherein said frozen composition has a core temperature less than or equal to −18° C. and greater than or equal to −40° C.

38. Process according to claim 35, wherein the frozen composition contains at least one fruit in the form of purée, pieces and/or juice.

39. Process according to claim 35, wherein the frozen composition contains 30 to 220% by weight fruit, in fruit equivalent, with respect to the total weight of the composition.

40. Process according to claim 35, wherein the frozen composition contains 51 to 70% by weight fermented milk, with respect to the total weight of the composition.

41. Process according to claim 35, wherein the frozen composition contains at least 10⁵ bacteria per gram.

42. Process according to claim 35, wherein the frozen composition contains one or more added sugars in an amount so that the composition contains less than 25% by weight carbohydrates, with respect to the total weight of the composition.

43. Process according to claim 35, wherein the frozen composition does not contain any of the following constituents: food additives (in the sense of the Codex alimentarium), emulsifiers, coloring agents, preservatives, starch, gelatin, flavoring agents, egg yolk, and mixtures thereof.

44. Process according to claim 35, wherein the frozen composition contains 0 to 6% by weight fat, with respect to the total weight of the composition.

45. Process according to claim 35, wherein the frozen composition contains 1.5 to 3% by weight protein with respect to the total weight of the composition.

46. Process according to claim 35, wherein said grinding means include a grinding element equipped with rotary blades, mounted at the end of an axle that is adjusted so as to move longitudinally, perpendicularly to the plane of said blades.

47. Process according to claim 35, wherein said device also comprises aeration means.

48. Process according to claim 36, wherein the additional liquid composition contains less than 20% by weight fat, less than 30% by weight sugar and less than 5% by weight alcohol.

49. Process according to claim 48, wherein the additional liquid composition contains or consists of at least one of the following constituents: fermented or non-fermented milk, fruit juice, a liquid fruit purée, a soluble fiber syrup, and mixtures thereof.

50. Process according to claim 36, wherein the additional liquid composition is used in an amount of 5 to 10% by weight, with respect to the weight of the frozen composition.

51. Process according to claim 35, wherein the additional powdered composition includes or consists of at least one constituent chosen from: dietary fibers, vitamins, minerals, antioxidants, proteins, probiotics, prebiotics and mixtures thereof.

52. Process according to claim 35, wherein the additional powdered composition is added in an amount representing 1 to 20% by weight, with respect to the weight of the frozen composition.
